(19) United States
(12) Patent Application Publication
(10) Pub. No.: US 2007/0011664 A1
(43) Pub. Date: Jan. 11, 2007

(54) DEVICE AND METHOD FOR GENERATING AN INSTRUCTION SET SIMULATOR

(75) Inventor: Hiroyuki YAMASHITA, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/424,304

(22) Filed: Jun. 15, 2006

(30) Foreign Application Priority Data
Jun. 16, 2005 (JP) 2005-176030

(51) Int. Cl. G06F 9/44

(52) U.S. Cl. 717/135; 717/138

(57) ABSTRACT

An instruction-set-simulator generating device that generates an instruction-set-simulator program for simulating an instruction execution process of a real central processing unit on a host central processing unit that differs from the real central processing unit, the instruction-set-simulator generating device comprises: an application-program reading unit that reads an application program that is executable on the real central processing unit; an execution-stage instruction conversion unit that converts a function of an instruction in the application program into at least one instruction (execution-stage instruction) for simulation on the host central processing unit; a fetch-stage instruction generating unit that generates at least one instruction (fetch-stage instruction) that simulates operation timing of an instruction fetch stage among pipeline stages of the real central processing unit prior to the execution-stage instruction; and an instruction-set-simulator program output unit that generates the instruction-set-simulator program based on the execution-stage instruction and the fetch-stage instruction; at least one of the execution-stage instruction conversion unit and the fetch-stage instruction generating unit generating a counter instruction for simulating an execution time of the real central processing unit.

### BACKGROUND OF THE INVENTION

1. Technical Field

The present invention relates to a device and method for generating a program that simulates processor operations.

2. Related Art

In a cross-development environment where a target (development object) and a host have different types of central processing units (CPUs), simulation methods for examining functions and timing of the target have been often used to develop an application program for an embedded device. One of such methods makes an instruction set simulator (ISS) that handles processing equivalent to that achieved by a CPU included in the target (hereinafter referred to as a “real CPU”) read an application program for processing. JP-A-2003-216678 (pp. 13-14, FIG. 11) is an example of related art. In related art, a method has been disclosed to simulate operations for each pipeline stage by reading an instruction set included in an application program and dividing the instruction set for each pipeline stage of the real CPU.

FIG. 19 illustrates a method to develop an application program for an embedded device with an ISS. An embedded software development tool 900 that operates on a generic computer having a host CPU is used to create an executable file of an application program. Specifically, a source code 930 of the program is created, and then the source code is compiled by a cross-compiler 920 for a real CPU to create a binary executable file 910 that is executable on the embedded device. An ISS 950 is used to examine operations. It simulates operations of the real CPU on a host CPU. It reads the executable file 910 and stores the file in a memory 940. The ISS 950 then reads one instruction at a time and simulates stages of fetch 960, decode 970, and execution 980 on the pipeline of the real CPU to operate the program.

The related art method requires the ISS for execution to read and analyze instructions in the application program and divide it for each pipeline stage. Analyzing instructions and separating them for each pipeline stage are particularly time-consuming. Therefore, the execution speed of the ISS reduces, thereby requiring time for examining the program and increasing development time and cost.

### SUMMARY

An advantage of the present invention is to provide a device that generates an ISS capable of examining operations and execution time of an application program at high speed.

An instruction-set-simulator (ISS) generating device according to an aspect of the invention is a device that generates an ISS program for simulating an instruction execution process of a real central processing unit (CPU) on a host CPU that differs from the CPU. The ISS generating device includes: an application-program reading unit that reads an application program that is executable on the real CPU, an execution-stage instruction conversion unit that converts a function of an instruction in the application program into at least one instruction (execution-stage instruction) for simulation on the host CPU, a fetch-stage instruction generating unit that generates at least one instruction (fetch-stage instruction) that simulates operation timing of an instruction fetch stage among pipeline stages of the real CPU prior to the execution-stage instruction, and an ISS program output unit that generates the ISS program based on the execution-stage instruction and the fetch-stage instruction. At least one of the execution-stage instruction conversion unit and the fetch-stage instruction generating unit generates a counter instruction for simulating an execution time of the real CPU.

The ISS generating device reads the application program and converts it into the instruction (execution-stage instruction) for the host CPU to execute functions that are identical to those of the program. Also, the fetch-stage instruction operating on the same timing as the fetch stage of the real CPU is generated. Moreover, the execution- or fetch-stage instruction is provided with a counter instruction for simulating a clock of the real CPU. Therefore, the ISS program can simulate the fetch- and execution-stages that have a large influence on operation time on the pipeline of the real CPU in consideration of the clock. In addition, since instructions are converted into ones that are executable on the host CPU, and there is no decode stage that delays operation time, the device operates at high speed.

According to the present aspect, the fetch-stage instruction generating unit may determine timing of executing the fetch-stage instruction depending on time from start of the fetch stage to start of the execution stage among the pipeline stages of the real CPU. It is therefore possible to accurately simulate the number and time of fetch-stage execution at execution of the application program, even with a number of pipeline stages in which the fetch stage is executed twice or more before the execution stage.

According to the present aspect, the ISS generating device may also include an instruction conversion information storage unit that stores instruction conversion information that sets correspondence between an instruction in the application program and the execution-stage instruction. In this case, the execution-stage instruction conversion unit converts an instruction in the application program into the execution-stage instruction with reference to the instruction conversion information. It is therefore possible to easily cope with other CPUs simply by changing the instruction conversion information.

According to the present aspect, the instruction conversion information may include information of an instruction execution-cycle number on the real CPU, and the execution-stage instruction conversion unit may generate the counter instruction for counting the execution-cycle number. It is therefore possible to easily cope with other CPUs simply by changing the instruction conversion information. Furthermore, since the execution-cycle number can be counted by the execution stage based on the execution-cycle number included in the instruction conversion information, it is possible to more accurately measure the execution-cycle number of the application program.

According to the present aspect, the fetch-stage instruction generating unit may generate the counter instruction for counting a fetch cycle in the pipeline stages of the real CPU. Since this structure provides counting by the fetch cycle, it is possible to more accurately measure the execution-cycle number even if the fetch and execution cycles operate in parallel.

According to the present aspect, the ISS generating device may also include an address search unit that searches a start address of the application program and a caller's address and a callee's address for branching, and an address information setting unit that sets address information that specifies the start address of the application program and the caller's and callee's addresses in the ISS program. Thus the start address of the application program and the caller's and callee's addresses are identified. If the information is incorporated into ISS generated by the ISS generating device as a label, it is possible to easily see correspondence between an execution position of ISS at its execution and a position in the application program and thus to examine the program easily.

According to the present aspect, if the callee's address is designated by indirect addressing for designating a specific location storing the callee's address to designate the callee's address, the address search unit may trace back instructions from a branch instruction to specify the callee's address among data stored in the specific location. It is therefore possible to identify the callee, even if the application program uses indirect addressing.

According to the present aspect, the address search unit may search the start address of the application program and the caller's and callee's addresses for branching with reference to the address information output at generation of the application program. The application program is usually generated by compiling a C-language source program, for example. While compiling the source program, a file is output that stores information, such as the address and instructions of the application program and the callee's label. Using this file makes it easy to identify the callee's address.

According to the present aspect, the execution-stage instruction conversion unit may judge whether a flag of a status register changed by an instruction in the application program is required for subsequent processing, and if not, opt not to generate an instruction for changing the flag. It is therefore possible to omit an instruction for setting an unnecessary status register without changing operation of the application program, thereby increasing the execution speed of ISS.

According to the present aspect, the execution-stage instruction conversion unit may replace two or more instructions in row in the application program with a smaller number of instruction(s) with an identical function. It is therefore possible to identify the callee, even if the application program uses indirect addressing. The number of execution-stage instructions of the ISS program can be thus reduced, thereby increasing the execution speed of ISS.

According to the present aspect, the ISS generating device may also include a generating unit that generates at least one of an instruction for simulating a status of a stack of the real CPU and an instruction for simulating a value of a program counter of the real CPU. It is therefore possible to see the status of the stack of the real CPU or the value of the program counter of the real CPU at the execution of ISS and thus to examine the application program more easily.

According to the present aspect, the ISS generating device may also include a generating unit that generates at least one of an instruction for outputting a status of a flag of the status register of the real CPU, an instruction for outputting a status of the stack, and an instruction for outputting a value of the program counter of the real CPU. It is therefore possible to output the contents of the status register of the real CPU, the status of the stack of the real CPU, or the value of the program counter of the real CPU as a log at the execution of ISS. Thus it is possible to readily see the status of the application program that is being executed.

According to the present aspect of the invention, the ISS generating device may also include a selection unit that selects an instruction to be generated among an instruction for outputting a status of a flag of the status register of the real CPU, an instruction for outputting a status of the stack of the real CPU, and an instruction for outputting a value of the program counter of the real CPU. It is therefore possible not to output unnecessary information out of the contents of the status register of the real CPU, the status of the stack of the real CPU, or the value of the program counter of the real CPU. Thus it is possible to execute ISS at high speed.

An ISS generating method according to another aspect of the invention is a method that generates an ISS program for simulating an instruction execution process of a real CPU on a host CPU that differs from the real CPU. The method includes: reading an application program that is executable on the real CPU, converting a function of an instruction in the application program into at least one instruction (execution-stage instruction) for simulation on the host CPU, generating at least one instruction (fetch-stage instruction) that simulates operation timing of an instruction fetch stage among pipeline stages of the real CPU prior to the execution-stage instruction, and outputting the ISS program to generate the ISS program based on the execution-stage instruction and the fetch-stage instruction. At least one of the step of converting into the execution-stage instruction and the step of generating the fetch-stage instruction generates a counter instruction for simulating an execution time of the real CPU.

This structure provides the same effects as achieved by the ISS generating device according to the above-described aspect.

An ISS generating program according to yet another aspect of the invention is a program that makes a computer achieve a function that generates an ISS program for simulating an instruction execution process of a real CPU on a host CPU that differs from the real CPU. The program further makes the computer function as: an application-program reading unit that reads an application program that is executable on the real CPU, an execution-stage instruction conversion unit that converts a function of an instruction in the application program into at least one instruction (execution-stage instruction) for simulation on the host CPU, a fetch-stage instruction generating unit that incorporates at least one instruction (fetch-stage instruction) that simulates operation timing of an instruction fetch stage among pipeline stages of the real CPU prior to the execution-stage instruction, and an ISS program output unit that generates the ISS program based on the execution-stage instruction and the fetch-stage instruction. One of the execution-stage instruction conversion unit and the fetch-stage instruction generating unit generates a counter instruction for simulating a clock of the real CPU.

This structure provides the same effects as achieved by the ISS generating device according to the above-described aspect.

According to the present aspect, the fetch-stage instruction generating unit may determine timing of executing the fetch-stage instruction depending on time from start of the fetch stage to start of the execution stage among the pipeline stages of the real CPU. This structure provides the same effects as achieved by the ISS generating device according to the above-described aspect.

According to the present aspect, the program may also make the computer function as an instruction conversion information storage unit that stores instruction conversion information that sets correspondence between an instruction in the application program and the execution-stage instruction. In this case, the execution-stage instruction conversion unit converts an instruction in the application program into the execution-stage instruction with reference to the instruction conversion information. This structure provides the same effects as achieved by the ISS generating device according to the above-described aspect.

According to the present aspect, the instruction conversion information may include information of an instruction execution-cycle number on the real CPU, and the execution-stage instruction conversion unit may generate the counter instruction for counting the execution-cycle number. This structure provides the same effects as achieved by the ISS generating device according to the above-described aspect.

According to the present aspect, the fetch-stage instruction generating unit may generate the counter instruction for counting a fetch cycle in the pipeline stages of the real CPU. This structure provides the same effects as achieved by the ISS generating device according to the above-described aspect.

According to the present aspect, the program may also make the computer function as: an address search unit that searches a start address of the application program and a caller's address and a callee's address for branching, and an address information setting unit that sets address information that specifies the start address of the application program and the caller's and callee's addresses in the ISS program. This structure provides the same effects as achieved by the ISS generating device according to the above-described aspect.

A computer-readable storage medium according to still further aspect of the invention stores the above-described ISS generating program. This structure provides the same effects as achieved by the ISS generating device according to the above-described aspect.

An ISS program according to another aspect of the invention is a program generated by the ISS generating device according to the above-described aspect. The ISS program makes a computer achieve: a first function that simulates operation timing of a fetch stage among the pipeline stages at execution of the application program on the real CPU, a second function that simulates a function of an execution stage among the pipeline stages at execution of the application program on the real CPU, and a third function that simulates an execution-cycle number of the application program on the real CPU.

Therefore, the ISS program can simulate the fetch- and execution-stages that have a large influence on operation time on the pipeline of the real CPU in consideration of the clock. In addition, since instructions are converted into ones that are executable on the host CPU, and there is no decode stage that delays operation time, the device operates at high speed.

An ISS system according to yet another aspect of the invention is a system that simulates an instruction execution process of an application program on a host CPU that differs from a real CPU. The ISS system includes: the ISS generating device according to the above-described aspect of the invention, a compiling device that compiles the ISS program generated by the ISS generating device and generating an ISS execution program that is executable on the host CPU, and an ISS device that stores the ISS execution program. The ISS device executes the ISS execution program on the host CPU.

Accordingly, the ISS generating device readily generates the ISS program from the application program. The compiling device compiles the ISS program and generates the ISS execution program that is executable on the host CPU. The ISS device having the host CPU stores the ISS execution program in its memory to execute the program, thereby simulating the application program. The ISS program generated by the ISS generating device can simulate the fetch- and execution-stages that have a large influence on operation time on the pipeline of the real CPU in consideration of the clock of the real CPU. In addition, since instructions are converted into ones that are executable on the host CPU, and there is no decode stage that delays operation time, the device operates at high speed. It is therefore possible to reduce time from generating the application program to completing simulations and to reduce time of developing the application program.

### BRIEF DESCRIPTION OF THE DRAWINGS

The invention will be described with reference to the accompanying drawings, wherein like numbers reference like elements.

FIGS. 1A and 1B illustrate a schematic structure of an instruction-set-simulator (ISS) generating device according to an embodiment of the invention.

FIG. 2 illustrates pipeline operations of a CPU with a four-stage pipeline.

FIGS. 3A and 3B illustrate the operation timing of a three-stage pipeline.

FIGS. 4A and 4B illustrate the operation timing of a four-stage pipeline.

FIG. 5 illustrates a process to develop an application program.

FIG. 6 is a flowchart illustrating a whole process of the ISS generating device.

FIG. 7 is a flowchart illustrating a process to read an application program.

FIG. 8 is a flowchart illustrating a process to search addresses and set address information.

FIG. 9 is a flowchart illustrating a process to eliminate redundancy codes.

FIG. 10 is a flowchart illustrating a process to convert into executive instructions.

FIG. 11 is a flowchart illustrating a process to output an ISS C-source.

FIG. 12A shows an instruction database.

FIG. 12B shows caller's information.

FIG. 12C shows callee's information.

FIG. 13 illustrates a technology file.

FIG. 14 is a flowchart illustrating a fetch instruction process.

FIGS. 15A and 15B show redundancy-code patterns and redundancy-code elimination instructions.

FIG. 16 illustrates an inner structure of the real CPU.

FIG. 17 illustrates a C-source file generated by the ISS generating device.

FIG. 18 illustrates how unnecessary flags are deleted.

FIG. 19 illustrates operations of a related art ISS.

### DESCRIPTION OF THE EMBODIMENT

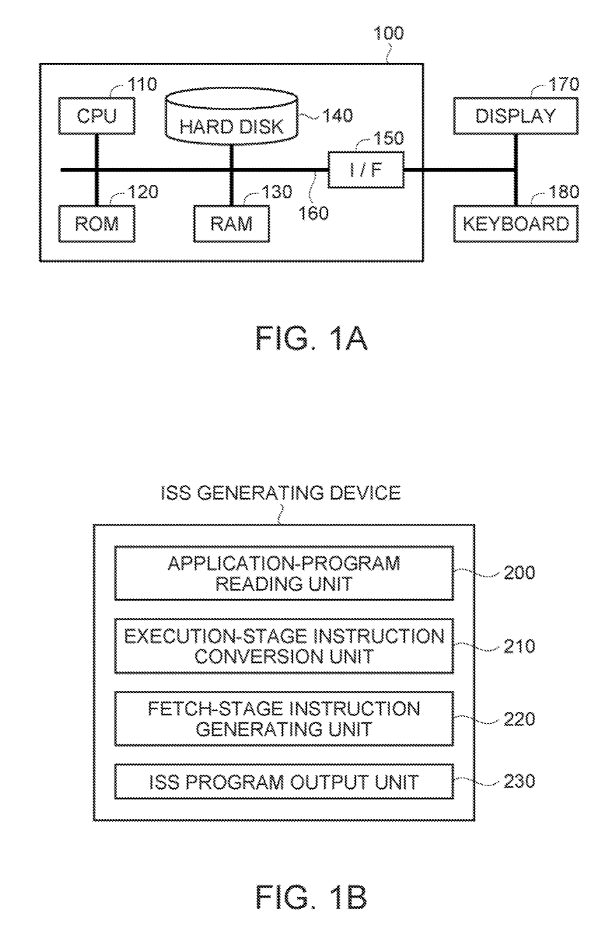

An embodiment of the invention will now be described. FIGS. 1A and 1B illustrate a schematic structure of an instruction-set-simulator (ISS) generating device according to an embodiment of the invention. This ISS generating device is a generic computer and includes a central processing unit (CPU) 110, a read-only memory (ROM) 120, a random access memory (RAM) 130, a hard disk 140, and an interface (I/F) 150 that are coupled to each other via a bus 160. Coupled to the I/F 150 are a keyboard 180 used to input instructions to the ISS generating device, and a display 170 to display the status of operations of the ISS generating device. It is also possible to couple a communication device (e.g. network) and a memory to this computer 100 to provide it with a program or data as necessary.

According to the present embodiment, a binary executable file of an application program that is compiled by a cross-compiler for a real CPU is stored in the RAM 130 or the hard disk 140 and is processed by the ISS generating device.

The CPU 110 performs predetermined processing to the application program stored in the RAM 130 or the hard disk 140 and stores the processed program as an ISS program to simulate the program's operations on the real CPU again in the RAM 130 or the hard disk 140.

The program including a record of generating ISS may be stored in the hard disk 140 or the RAM 130 in advance. Alternatively, the program may be supplied from the outside by a computer-readable storage medium, such as a CD-ROM, and stored in the hard disk 140 through a CD-R/RW drive (not shown). Furthermore, the program may be stored in the hard disk 140 by making access to a server or the like that supplies the program through a network, such as the Internet, and downloading the data.

The CPU 110 reads an ISS generating program stored in the hard disk 140 or the ROM 120 via the bus 160 and performs the program with a predetermined operating system, thereby functioning as an ISS generating device. As shown in FIG. 1B, it functions as an application-program reading unit 200, an execution-stage instruction conversion unit 210, a fetch-stage instruction generating unit 220, and an ISS program output unit 230.

Each component works as follows. The application-program reading unit 200 reads the application program stored in the RAM 130 or the hard disk 140, acquires a start address of the program and information on the address and instructions, and stores them in the RAM 130 or the hard disk 140.

The execution-stage instruction conversion unit 210 first examines a branch instruction in the program with the information on the address and instructions, and sets a label for a callee. The unit then converts the instructions of the program into ones that are executable on a host computer (i.e., execution-stage instructions). Examples of such execution-stage instructions may include instructions to simulate the real CPU's register, status register, stack, program counter, and execution time as well as instructions to perform functions that are identical to those of the real CPU.

The fetch-stage instruction generating unit 220 generates instructions for the fetch stage on the real CPU's pipeline (i.e., fetch-stage instructions) and insert them before the execution-stage instructions. The ISS program output unit 230 outputs a C-language source code that is compilable on the host CPU based on the execution- and fetch-stage instructions. A compiler included in the host CPU compiles the C-language source code to execute it, whereby the ISS that can examine operations of the application program on the real CPU is achieved.

By generating the execution- and fetch-stage instructions, the operation timing and time of the fetch and execution stages on the real CPU's pipeline can be simulated.

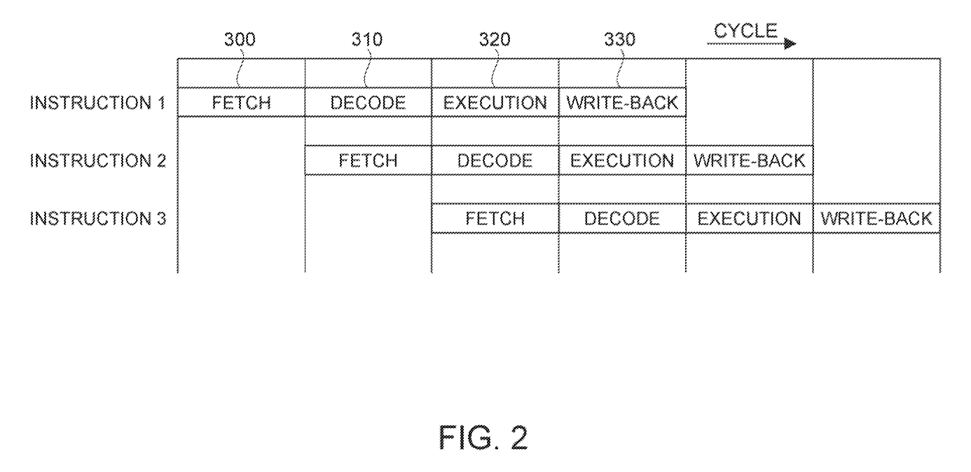

FIG. 2 illustrates pipeline operations of a CPU with a four-stage pipeline. In the four-stage pipeline, an instruction is divided into the four stages of fetch 300, decode 310, execution 320, and write-back 330 for execution. The fetch stage 300 is to make access to a program instruction and read the instruction. The decode stage 310 is to generate internal signals that are necessary for analysis and execution of the instruction. The execution stage 320 is to execute an operation designated by the instruction. The write-back stage 330 is to write operation results in a memory or register. As shown in FIG. 2, Instructions 1 to 3 are executed in a way that a subsequent instruction stays one-stage behind a preceding one. Therefore, the execution time for Instructions 1 to 3 is a total of twice the execution time of the fetch stage, three times the execution time of the execution stage, and the execution time of the write-back stage. Since the execution time of the write-back stage needs to be considered only when the application program finishes, the fetch and execution stages are taken into consideration to simulate the operation timing and time of the application program in the present embodiment.

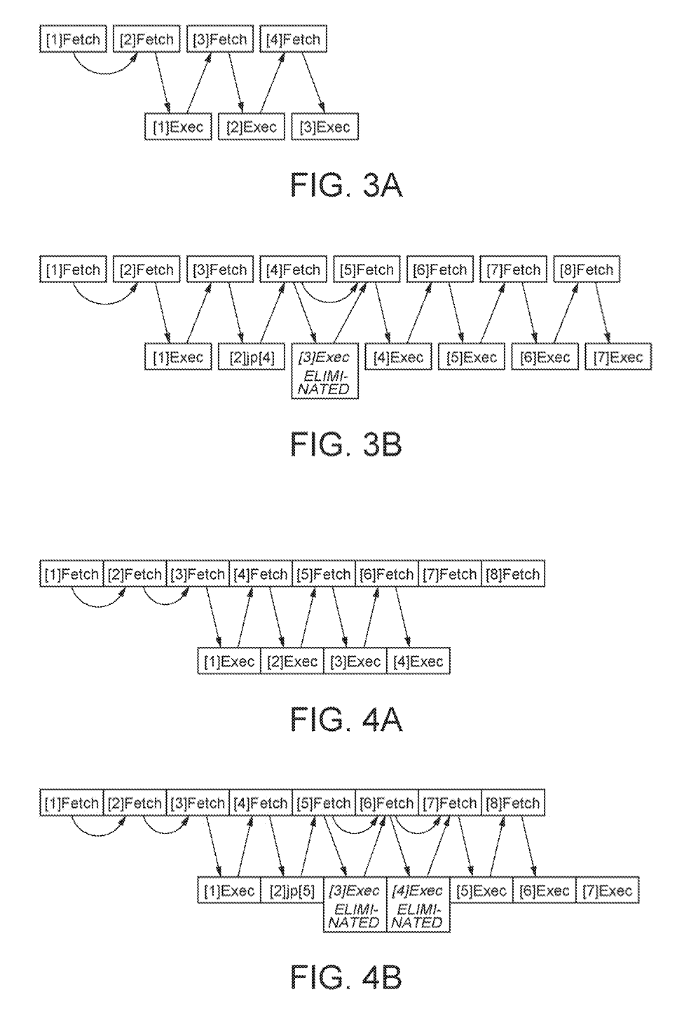

FIGS. 3A and 3B illustrate the operation timing of the fetch and execution stages with an ISS generated by the ISS generating device according to the present embodiment that is applied to a real CPU with a three-stage pipeline. Referring to FIGS. 3A and 3B, the fetch and execution stages of an instruction to be executed first are referred to as “[1] Fetch” and “[1] Exec”. Likewise, the fetch and execution stages of an instruction to be executed second are referred to as “[2] Fetch” and “[2] Exec”, the fetch and execution stages of an instruction to be executed in the Nth place are referred to as “[N] Fetch” and “[N] Exec”. As an example of the execution stage of a branch instruction that has a large influence on the pipeline's operations in the instruction, FIG. 3B shows an instruction for jumping from the second instruction to the fourth, which is referred to as “[2]jp[4]”. It is in the execution stage of the second instruction and means a branch to the fourth instruction after execution.

The fetch stage of the three-stage pipeline is executed one cycle prior to the execution stage. Accordingly, as shown in FIG. 3A, the execution process of an ISS program output by the ISS generating device according to the present embodiment goes as follows: [1] Fetch, [2] Fetch, [1] Exec, [3 Fetch, [2] Exec, and so forth. The execution time is a total of the execution time of the execution stages and the execution time of the fetch stage of the first instruction.

FIG. 3B shows a branch instruction from the second instruction to the fourth. In this case, the execution process skips [3] Exec and goes as follows: [2]jp[4], [4] Fetch, [5] Fetch, [4] Exec, [6] Fetch, and so forth. The execution time is a total of the execution time of the execution stages, [1] Fetch and [4] Fetch.

FIGS. 4A and 4B illustrate the operation timing of the fetch and execution stages with an ISS generated by the ISS generating device according to the present embodiment that is applied to a real CPU with a four-stage pipeline. The fetch stage of the four-stage pipeline is executed two cycles prior to the execution stage. Therefore, two fetch stages are executed in succession at the start of an application program and the execution of a branch instruction.

Accordingly, the order of fetch-stage and execution-stage instructions is adjusted in the present embodiment, so that the execution timing of the fetch and execution stages will be recovered. Moreover, the fetch-stage instruction and the execution-stage instruction have a counter each, so that the execution time will be accurately simulated. More specifically, the execution-stage instruction includes a counter instruction for counting the number of execution cycles that is set for each instruction. The fetch-stage instruction includes a counter instruction for counting the number of fetch-stage execution cycles and a process instruction for skipping a subsequent execution-stage instruction if a preceding execution-stage instruction is a branch instruction and executing a fetch-stage instruction corresponding to a callee's instruction. It is therefore possible to accurately count the number of execution cycles of the application program.

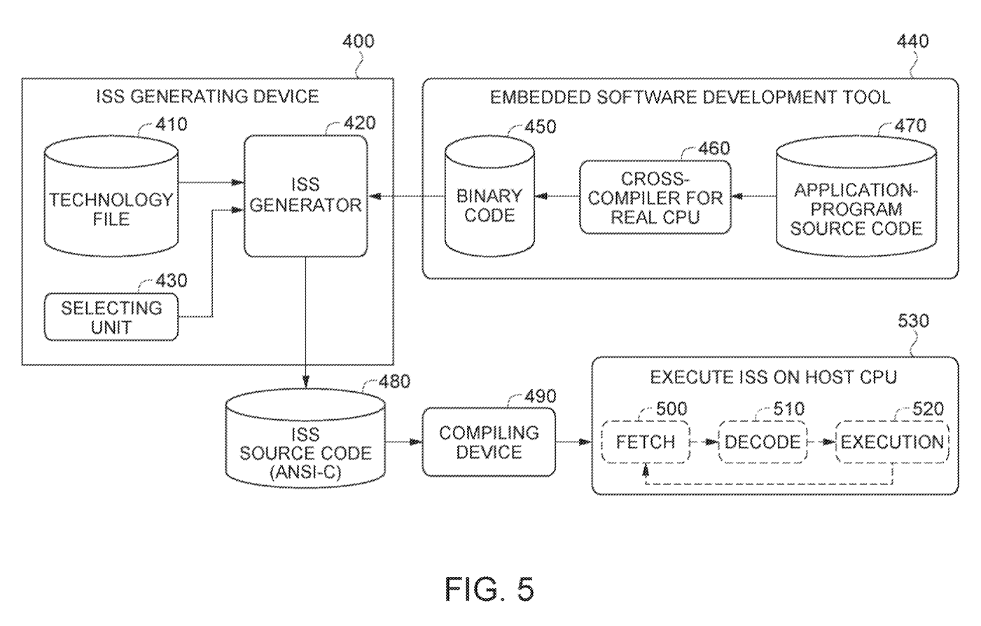

FIG. 5 illustrates an ISS system of an application program in which the ISS generating device according to the present embodiment is applied. The ISS system according to the present embodiment includes an ISS generating device 400, a compiling device 490, and an ISS device 530. The ISS generating device 400, the compiling device 490, and the ISS device 530 are generic computers. The ISS device 530 has a host CPU to execute file an ISS program.

An embedded software development tool 440 that operates on a host computer is used to develop an application program. A cross-compiler 460 for a real CPU compiles a source code 470 for the application program to create a binary executable file (binary code 450) that is executable on the real CPU. Then an ISS generator 420 included in the ISS generating device 400 reads the binary code 450. The ISS generator 420 converts the binary code 450 into an ISS source code 480 that is executable on the host CPU with reference to a technology file 410 in which corresponding information (instruction conversion information) on the real and host CPUs' instructions are stored. Here, a selecting unit 430 selects a type of log output information output at the execution of ISS. The selecting unit 430 requires a user to select the status of the status register, the status of the stack, or the value of the program counter to be output as a log with the keyboard 180.

The compiling device 490 compiles the ISS source code 480 with a compiler for the host CPU to create an ISS program that is executable on the host computer. By executing this ISS program on the ISS device 530, the simulation of the pipeline's operations of the real CPU is available. It is therefore possible to create and compile the application program, generate ISS, and operations with examine at high speed, thereby reducing time and cost for developing the program.

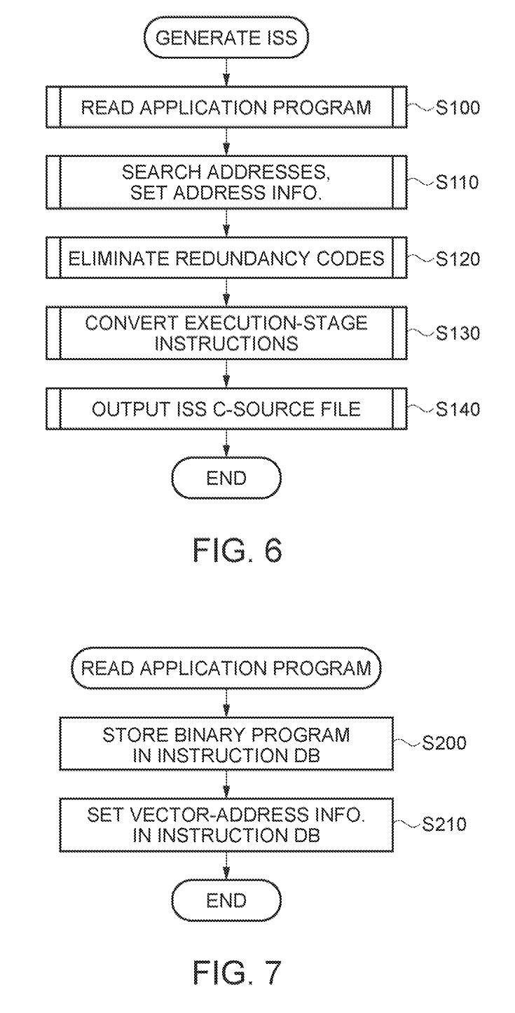

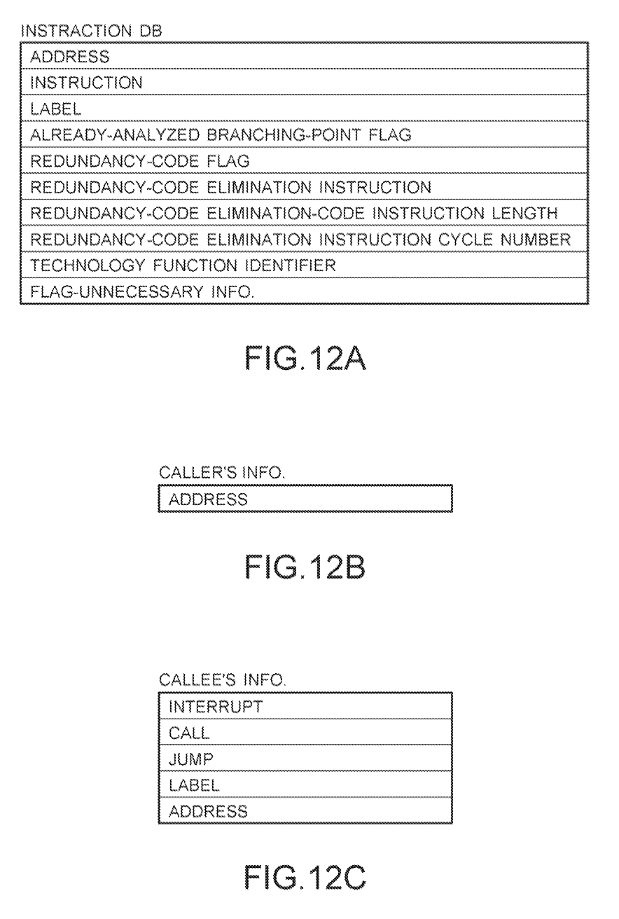

Referring now to the flowchart of FIG. 6, the process carried out by each component in the ISS generating device according to the present embodiment will be described. The process shown in FIG. 6 starts with Step S100 to read an application program and store information on the program in an instruction database and a callee's information. The instruction database is a working memory in which the items shown in FIG. 12A are stored. In this memory, all instructions of the program are stored. The callee's information is another working memory in which the items shown in FIG. 12C are stored. In this memory, the start address of the program and the callee's address for branching are stored.

The process here will now be described in greater detail with reference to the flowchart of FIG. 7. The process shown in FIG. 7 starts with Step S200 to read the binary application program and store instructions and the address of the real CPU for each instruction in the instruction database. The step is followed by Step S210 to acquire information on a vector address that is the start address of the program and store it in the callee's information. The start address in the instruction database is labeled. The label represents the address in text form, and is inserted in a C-language ISS program source file that is output by the ISS generating device.

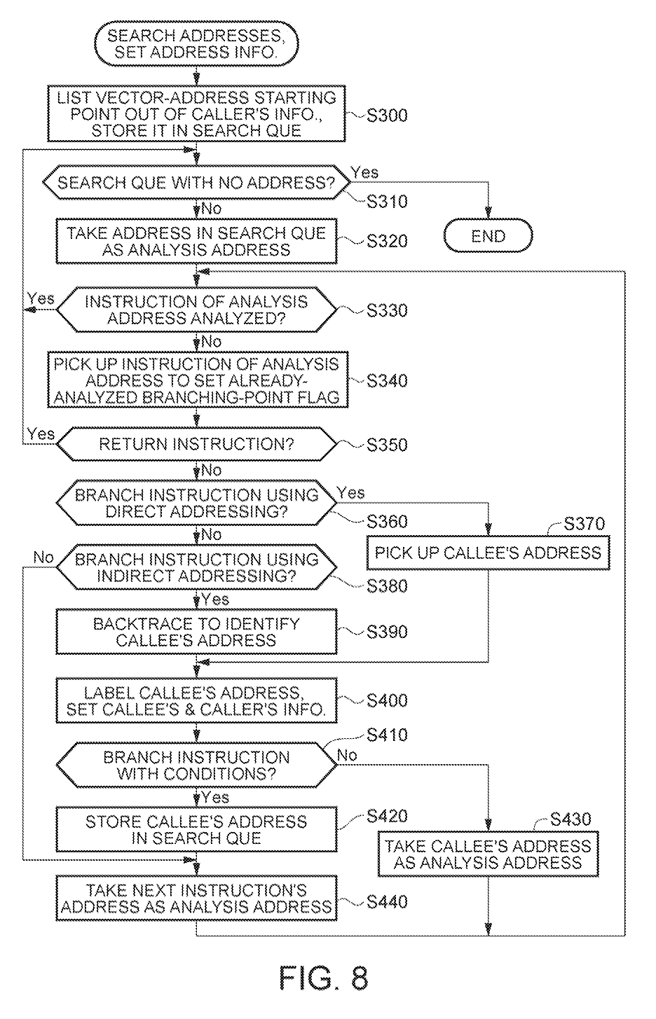

Step S110 follows as shown in FIG. 6 to search addresses and set address information. By identifying he start address, callee's address, and caller's address of the program and examining instructions of the program from the start address to the caller's address or from the callee's address to the caller's address, it is possible to analyze the instructions in the order of execution with no branch among them. Furthermore, the ISS generating device outputs the C-language ISS program source file. Putting labels in the ISS program source file that are corresponding to the start and callee's addresses makes it easy to see correspondence with the application program at the execution of ISS and thus to examine operations. Therefore, the process to search addresses and set address information is carried out by examining the instruction database to find a branch instruction, identifying the callee's and caller's addresses, and storing them. The process here will now be described in greater detail with reference to the flowchart of FIG. 8.

The process to search addresses and set address information starts with Step 300 to list a starting point that is a vector address out of the callee's information and store it in a search QUE. The start address of the application program for an embedded device starts with a vector address, such as a Reset vector. It is therefore possible to examine all instructions in the order of processing by searching an instruction with the vector address.

Step S310 follows to judge whether an address is in the search QUE. If it has no address, processing of all instructions is considered to be finished, which completes the process to search addresses and set address information. If it has any address, which means there remains processing to be carried out, the process goes onto Step S320.

Step S320 follows to pick up the address from the search QUE as an analysis address. By taking the analysis address out of the search QUE, the analysis address is removed from the search QUE.

Step S330 follows to judge whether an instruction designated by the analysis address has been already analyzed. If it has been analyzed, analysis of the instruction following the analysis address is considered to be finished, and the process goes onto Step S310. If it has not been analyzed yet, the process goes onto Step S340 to start the analysis of the instruction following the analysis address. Whether it has been analyzed or not is judged based on an already-analyzed ranching-point flag in the instruction database. The already-analyzed branching-point flag shows whether the process to search addresses and set address information is carried out for each instruction of the program. Then, Step S340 follows to set the flag to the instruction designated by the analysis address.

Step S350 follows to judge whether the instruction designated by the analysis address is a Return instruction from a function or interrupt processing. If it is a Return instruction, no instruction is considered to follow, and the process goes onto Step S310. If it is not a Return instruction, the process goes onto Step S360 to judge whether it is a branch instruction using direct addressing. According to the present embodiment, the branch instructions means a jump instruction, a jump instruction with conditions, a function-call instruction, a Return instruction from a function, or a Return instruction from interrupt processing. Here, whether the instruction is a branch instruction is judged to add the caller's address to the search QUE and to analyze instructions that cannot be reached through the order from the vector address. If the instruction is a branch instruction using direct addressing in Step S360, the process goes onto Step S370. If it is not a branch instruction using direct addressing, the process goes onto Step S380.

Step S370 follows to pick up the callee's address designated by direct addressing from the instruction. Then the process goes onto Step S400 to perform processing of the callee's address. Meanwhile, whether the instruction is a branch instruction using indirect addressing is judged in Step S380. If it is not a branch instruction using indirect addressing, the process goes onto Step S440 to analyze a subsequent instruction. If it is a branch instruction using indirect addressing, the process goes onto Step S390. Step S390 is to trace back an instruction from an analyzed address to find the instruction including the callee's address designated by the branch instruction and identify the callee's address. In Step 400, the callee's address of direct addressing or of indirect addressing is set in the callee's information and the caller's information. Also, a label corresponding to the callee's address is set in the instruction database. This label represents the callee's address in text form. The callee's information and the caller's information are data shown in FIGS. 12B and 12C and used for subsequent analyses and putting labels in a C-source output by the ISS generating device. Putting labels corresponding to the callee in the C-source makes it easy for an application-program developer to see correspondence between an execution position of ISS and a position in the application program at the execution and examination of ISS, thereby improving the efficiency of the development.

Then Step S410 follows to judge whether the instruction is a branch instruction with conditions. If it is a branch instruction with conditions, the process goes onto Step S420. If it is not a branch instruction with conditions, the process goes onto Step S430. More specifically, if it is a branch instruction with conditions, an instruction that comes next to the branch instruction is analyzed and the callee is stored in the search QUE to be analyzed afterward. If it is not a branch instruction with conditions, the callee's instruction is to be analyzed subsequently.

Step S420 is to store the callee's address of the branch instruction with conditions is stored in the search QUE. Then Step 440 follows to set the next address as the analysis address, and the process goes onto Step S330 to analyze the next instruction. Step 430 is to set the callee's address as the analysis address, and the process goes onto Step S330 to analyze the next instruction.

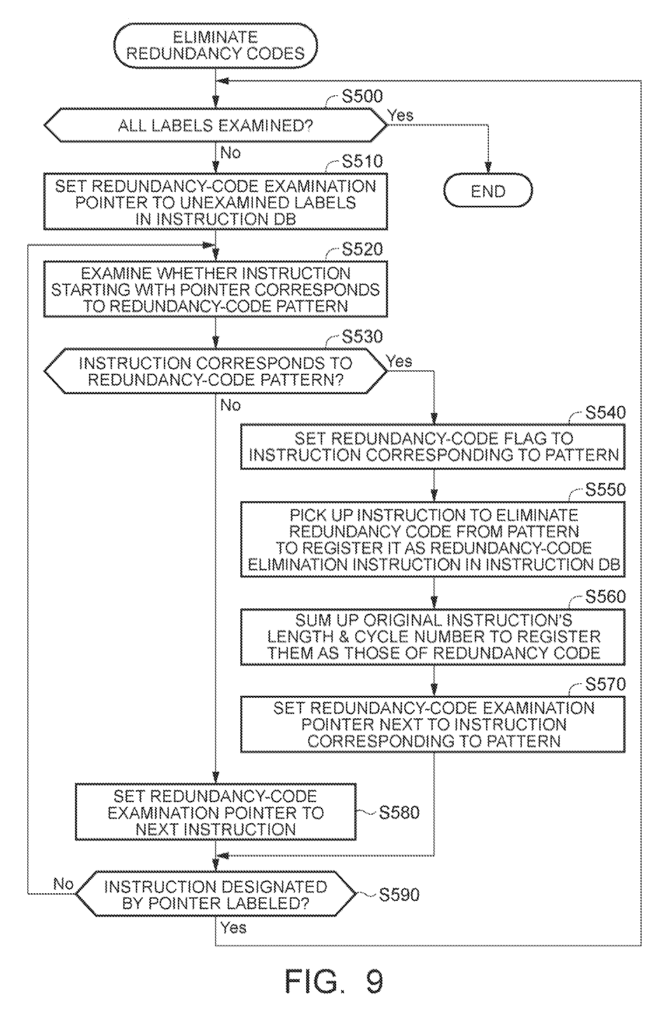

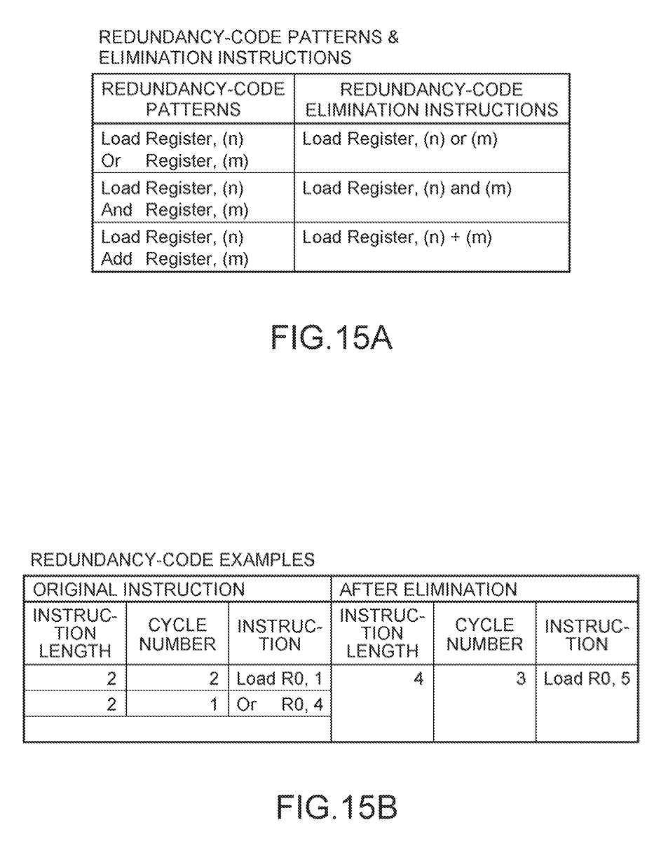

The process to search addresses and set address information is followed by the process to eliminate redundancy codes in Step S120 as shown in FIG. 6. The process here will now be described in greater detail with reference to the flowchart of FIG. 9. The process to eliminate redundancy codes aims to convert a plurality of instructions in the application program into a smaller number of instruction(s) of the host CPU with identical functions and reduce the number of the instructions executed with ISS, thereby increasing the speed of operations. For example, a combination of a Load instruction and an Or instruction leads to the same result as one Load instruction as shown in redundancy-code examples in FIG. 15. Accordingly, not both the Load and Or instructions but the Load instruction is executed to execute ISS on the host CPU. To keep the program counter and the number of execution cycles correctly, this Load instruction has the same number of execution cycles and instruction length as a total of the real Load and Or instructions. To achieve this, instructions in the instruction database are analyzed beforehand to search redundancy codes, and are replaced with instructions in which redundancy codes are eliminated.

The process to eliminate redundancy codes starts with Step S500 to judge whether all labels have been examined. In the process to eliminate redundancy codes, redundancy codes are examined with the labels set in the process to search addresses and set address information as starting points. Accordingly, no branching with conditions have to be handled while examining instructions, thereby simplifying the analysis. If all the labels have been examined, which means elimination has been carried out with every instruction, the process to eliminate redundancy codes finishes. If there remain any unexamined labels, the process goes onto Step S510.

Step S510 is to set a redundancy-code examination pointer to unexamined labels in the instruction database. Then Step S520 follows to examine whether an instruction starting with the redundancy-code examination pointer is a redundancy code. Specifically, this is achieved by examining whether any redundancy-code pattern shown in FIG. 15A corresponds to the instruction starting with the pointer. If there is an instruction corresponding to any redundancy-code pattern in Step S530, the process goes onto Step 540. If there is no instruction corresponding to redundancy-code patterns, the process goes onto Step 580.

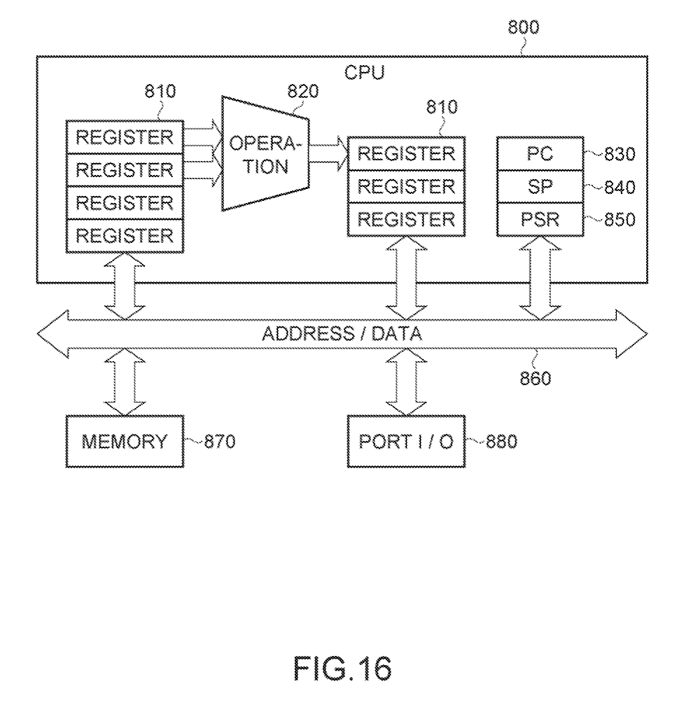

Step 540 is to set a redundancy-code flag of the instruction database corresponding to the instruction that corresponds to a redundancy-code pattern. Here, the flag is put to not only an instruction designated by the pointer but also every instruction that corresponds to a redundancy-code pattern. Then Step S550 follows to pick up an instruction for eliminating a redundancy code corresponding to the data of the redundancy-code patterns and elimination instructions shown in FIG. 16A, and register it in the redundancy-code elimination instructions of the instruction database. Then Step 560 follows to sum up the instruction length and the number of execution cycles of the instruction that corresponds to the redundancy-code pattern and to register the results in the instruction database. The total of the instruction length and the number of execution cycles of the instruction that corresponds to the redundancy-code pattern is used for ISS executed on the host CPU. Accordingly, the execution speed of ISS executed on the host CPU can be increased with the smaller number of instructions. Furthermore, the instruction length and the number of execution cycles that have an influence on the program counter remain to be the same as the original application program.

Then Step 570 follows to change the redundancy-code examination pointer to designate an instruction that comes next to the instruction that corresponds to the redundancy-code pattern. If the instruction does not correspond to any redundancy-code pattern, the process goes onto Step S580 to change the pointer to designate the next instruction. Then Step S590 follows to judge whether the instruction designated by the pointer is labeled. If it is labeled, the process goes onto Step 500. If it is not labeled, the process goes onto Step S520 to examine the next instruction. Every instruction is examined for redundancy codes in this manner.

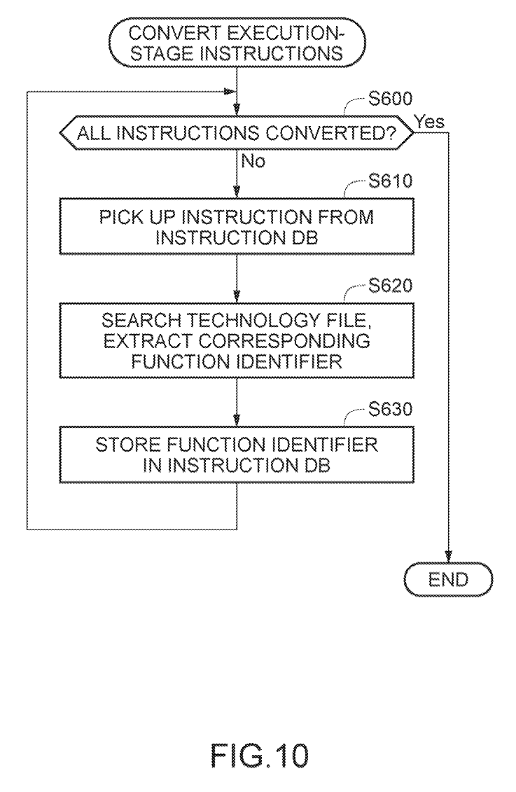

The process to eliminate redundancy codes is followed by the process to covert execution-stage instructions. The process here will now be described in greater detail with reference to the flowchart of FIG. 10.

The process to covert execution-stage instructions starts with Step S600 to judge whether all instructions have been converted. If all the instructions have been converted, the process to covert execution-stage instructions finishes. If there is any instructions that have not been converted, the process goes onto Step S610. Step S610 is to pick up an instruction from the instruction database. Then Step S620 follows to search a technology file (instruction conversion information memory unit) with the instruction that has taken out as a key to extract a function identifier.

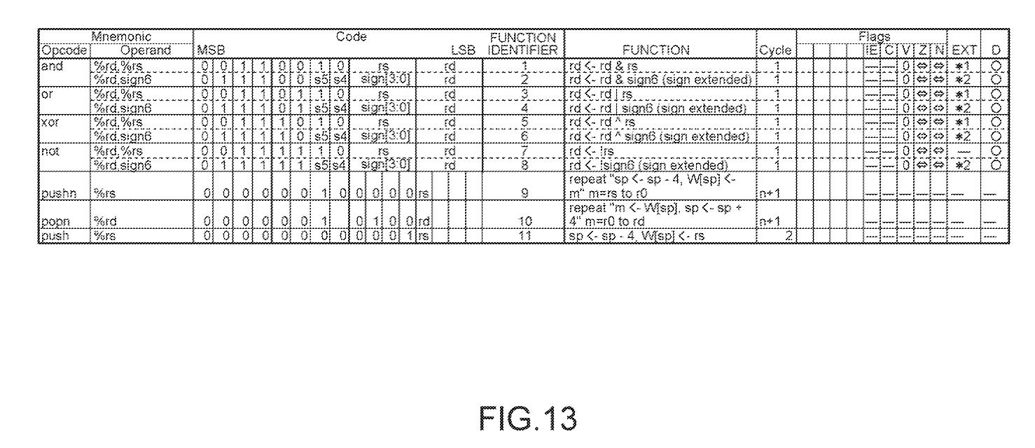

Referring now to FIG. 13, the technology file will be described. The technology file sets correspondence between the real CPU's instructions, the state transition of the status register, the number of execution cycles, and the host CPU's instructions. Instruction and operand formats, instruction operation code (opcode) and operand bit patterns, function identifiers that identify the host CPU's instructions, the host CPU's instructions, the number of execution cycles, and the state transition of the status register are stored from the left in FIG. 13. The function identifiers are assigned with the host CPU's functions that are defined separately. The host CPU's functions set the status register in a function. The function ion the popn opcode row is defined as: repeat”m←W[sp],sp←sp+4”m=r0tord. This is an instruction for simulating the status of the stack. By executing this instruction, the status of the stack is simulated.

Then Step S630 follows to register the function identifier that has been searched in the instruction database. Subsequently, the process goes back to Step S600 to convert a subsequent instruction.

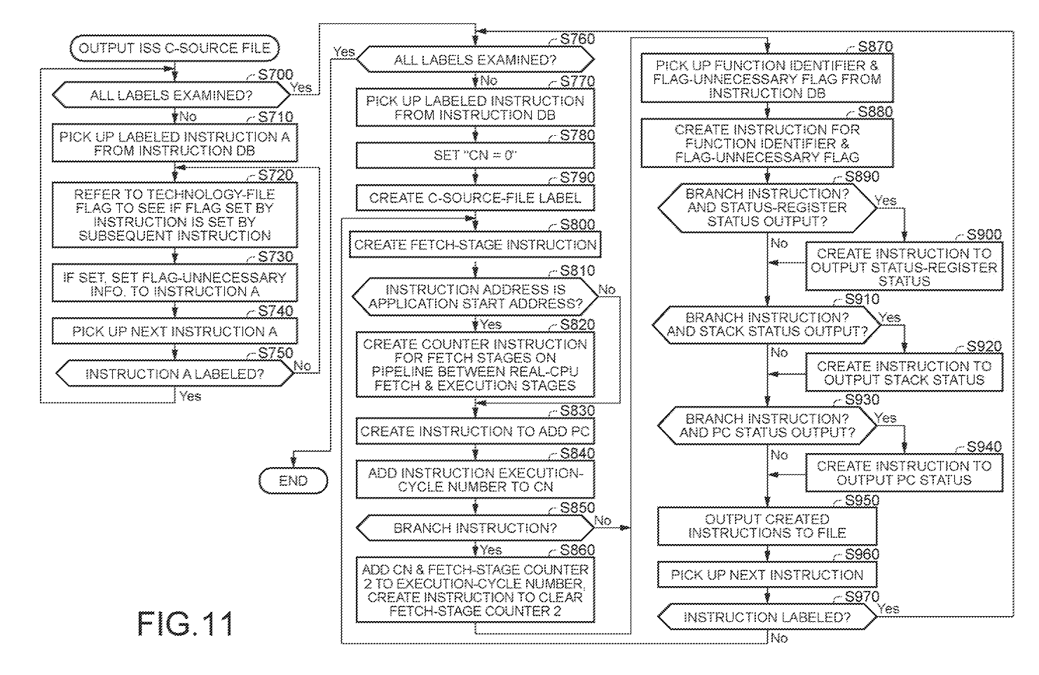

The process to covert execution-stage instructions is followed by the process to output an ISS C-source file. The process here will now be described in greater detail with reference to the flowchart of FIG. 11.

The process to output an ISS C-source file starts with Steps S700 to S750 to search where the status register that is unnecessary is set. FIG. 18 illustrates unnecessary flags that are set. In the example shown here, the instructions of add, cmp, and jreg are assigned to the addresses c00102, c00104, and c00106, respectively. The instruction jreg is to see the value of a Z flag in the status register to judge whether there is branching. Z flags are set at both the instructions add and cmp, but it is one set later at the instruction cmp that is actually used. Therefore, there is no influence on operations even if no Z flag is set at the instruction add. When the same flag is set twice in a row like this, the first one is unnecessarily set as it has no influence on operations. If ISS operated on the host CPU eliminates a code that sets such an unnecessary flag, it is possible to increase the execution speed without changing operations of ISS.

Step S700 is to judge whether the labels set in the process to search addresses and set address information have been examined. If all the labels have been examined, which means setting of unnecessary flags is considered to be finished, the process goes onto Step S760. If not all the labels have yet to be examined, the process goes onto Step S710 to examine unnecessary flags.

Step S710 is to pick up an instruction that is labeled and has not been examined from the instruction database as Instruction. Step S720 follows to examine the flag set by Instruction A with reference to the technology file, thereby examining instructions subsequent to Instruction A. Then Step S730 follows to set flag-unnecessary information (FIG. 12A) in the instruction database to Instruction A if an instruction for setting the same flag again before reaching another instruction for using the flag set by Instruction A or a branching instruction. The flag-unnecessary information includes Instruction A and the type of the flag that is set again by a subsequent instruction.

The process goes onto Step S610 to pick up an instruction an instruction that comes next to Instruction A as new Instruction A. Then Step S750 follows to judge whether new Instruction A is labeled. If not, the process goes onto Step S720 to process new Instruction A. If it is labeled, the process goes onto Step S700.

This process of searching unnecessary status registers in all instructions are followed by the process to output an ISS C-source (ISS program output unit) starting with Step S760. This process includes generating of a fetch-stage instruction in Steps S800 to S820 (fetch-stage instruction generating unit). This process also includes processing of execution-stage instruction conversion unit in Steps S830, S840, S870, and S880. The process to output an ISS C-source starts with Step S760 to judge whether all labels in the instruction database have been processed. If all the labels are processed, the process to output an ISS C-source finishes, which means the completion of processing with the ISS program output unit. If there remain any unprocessed labels, the process goes onto Step S770.

Step S770 is to pick up an instruction that is labeled and has not been processed from the instruction database. Subsequently, a variable CN is set to be zero in Step S780. Then Step S790 follows to create a C-language label that corresponds to a label in the instruction database. This label is a letter string including an address in the instruction database and set correspondence with the address of the original application program when creating a C-language ISS.

The process goes onto Step S800 to acquire an instruction for the fetch stage to create a fetch-stage instruction in the memory. Since a C-language instruction for the fetch stage is prepared in advance, the only step taken here is to pick up the C-language source code of the fetch instruction that has been prepared. In the fetch-stage instruction that has been prepared, a counter instruction for counting the number of fetch-stage execution cycles is incorporated. Thus, the fetch-stage and fetch-stage counter instructions can be generated simply by acquiring the fetch-stage instruction that has been prepared and incorporating them into appropriate positions.

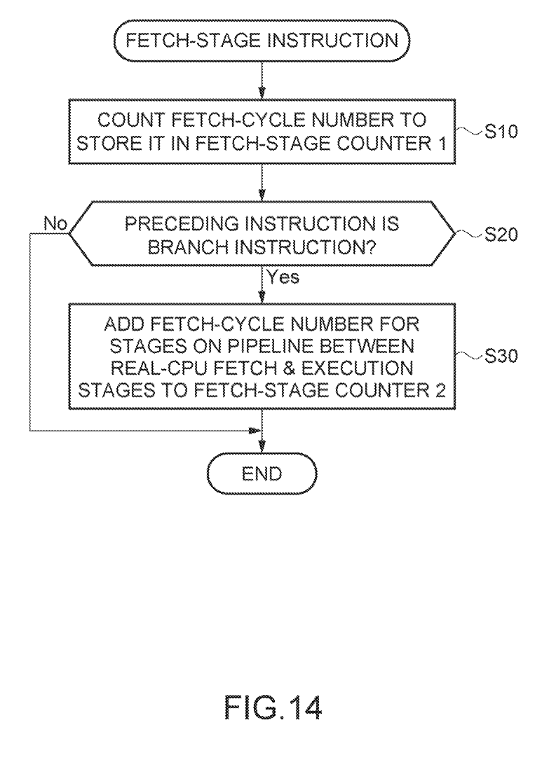

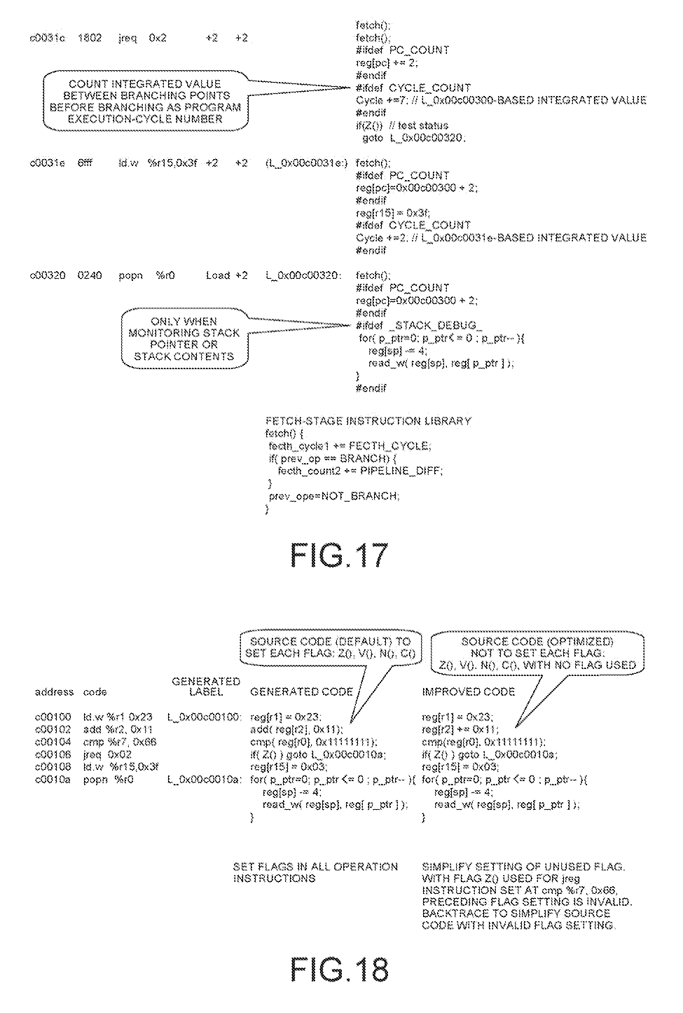

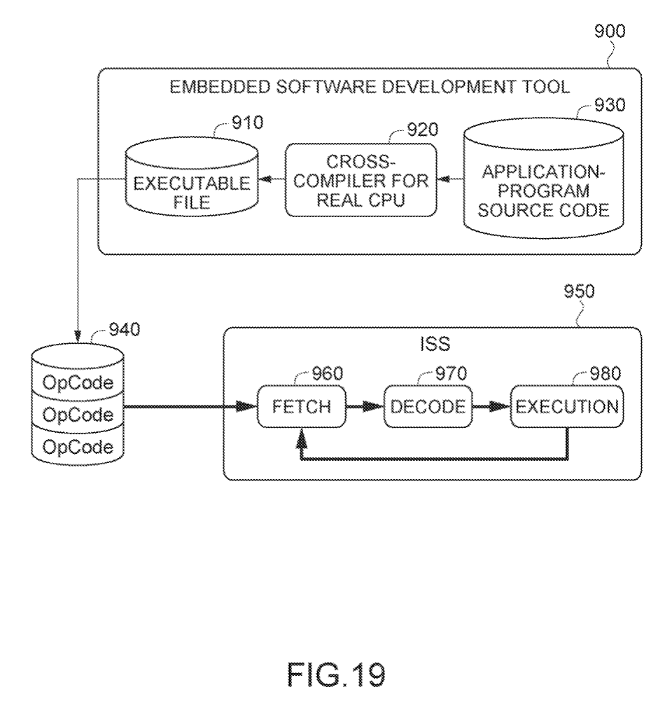

Referring now to the flowchart of FIG. 14, the C-language source code of the fetch instruction that is generated will be described. The fetch instruction starts with a counter instruction for counting the number of fetch cycles and store it in a fetch-cycle counter 1 in Step S10. Then Step S20 follows to judge whether a preceding instruction is a branch instruction. If it is a branch instruction, the process goes onto Step S30. If it is not a branch instruction, the process finishes. Step S30 is to execute a counter instruction for adding the number of fetch cycles for stages on the pipeline between the real CPU's fetch and execution stages to a fetch-stage counter 2. This step is to simulate fetch instructions coming in row just after the execution of the branch instruction as shown in FIGS. 3B and 4B. The flowchart of FIG. 14 is represented in a C-language source code in FIG. 17, which the fetch ( ) function of the fetch-stage instruction library. In the present embodiment, the ISS generating unit acquires the fetch ( ) function and incorporate it in an appropriate position.

Then process goes onto Step S810 to judge whether the address of the instruction is at the head (i.e., vector address) of the application program. If it is at the head of the application program, the process goes onto Step S820. If it is not at the head of the application program, the process goes onto Step S830. Step S820 is to generate a fetch-stage instruction including a counter instruction for stages on the pipeline between the real CPU's fetch and execution stages. At the head of the application program, this process makes a time period from the first fetch stage to the first execution stage correspond to an execution timing of the fetch stage and the execution stage on the real CPU's pipe line. This step is to simulate the fetch stage executed prior to the first execution stage [1] Exec in FIGS. 3 and 4.

The process goes onto Step S830 to create an instruction for adding the length of the instruction to a program counter PC to simulate the status of the real CPU's program counter. Then Step S840 follows to add the number of execution cycles of the instruction to CN. The next Step S850 is to judge whether the instruction is a branch instruction. If it is, the process goes onto Step S860 to add CN and the fetch-stage counter 2 to the counter of execution cycles and then create an instruction for clearing the fetch-stage counter 2. Accordingly, the number of execution cycles including the fetch stages from the head of the label to a branch instruction is stored in the execution-cycle counter, and an instruction for counting the number of the real CPU's execution cycles is created. Meanwhile, if it not is a branch instruction, the process goes onto Step S870.

Step S870 is to pick up the function identifier and the flag-unnecessary flag from the instruction database. Step S880 follows to create an instruction corresponding to the function identifier and the flag-unnecessary flag from the instruction database.

Instructions for creating the status of the status register, the stack, and the program counter are created from Steps S890 to S940. In Steps S890, S910, and S930, whether the status of the status register, the stack, and the program counter are output as selected with a selecting unit that reads a direction made by a user of the ISS generating device with the keyboard 180.

The next Step S890 is to judge whether the instruction is a branch instruction and whether output of the status of the status register is directed with the selecting unit. If the instruction is a branch instruction with the direction to output the content of the status register, the process goes onto Step S900 to create an instruction for outputting the content of the state register, that is, an instruction for showing the content of the state register on a display with a C-language printf instruction. If the instruction is not a branch instruction or output of the content of the status register is not directed, the process goes onto Step S910.

Step S910 is to judge whether the instruction is a branch instruction and whether output of the status of the stack is directed with the selecting unit. If the instruction is a branch instruction with the direction to output the content of the stack, the process goes onto Step S920 to create an instruction for outputting the content of the stack, that is, an instruction for showing the value of the stack pointer and the content of the stack on a display with a C-language printf instruction. If the instruction is not a branch instruction or output of the content of the stack is not directed, the process goes onto Step S930.

Step S930 is to judge whether the instruction is a branch instruction and whether output of the value of program counter PC is directed with the selecting unit. If the instruction is a branch instruction with the direction to output the value of the program counter PC, the process goes onto Step S940 to create an instruction for outputting the value of the program counter PC, that is, an instruction for showing the value of the program counter PC on a display with a C-language printf instruction. If the instruction is not a branch instruction or output of the value of the program counter PC is not directed, the process goes onto Step S950.

Step S950 is to write out the instruction that has been created to a file. The process goes onto Step S960 to pick up a subsequent instruction. The next Step S970 is to judge whether the instruction is labeled. If not, the process goes onto Step S800 to create the C-source of this instruction. If it is not labeled, the process goes back to Step S760 to process the label whose C-source has yet to be output. Thus, unnecessary flags are eliminated, fetch instructions are generated, log outputs are selected and generated, and C-source files are output for all instructions.

FIG. 16 illustrates an inner structure of a real CPU 800. A memory 870 or a port I/O 880 is coupled to a register 810 via a bus 860, making it possible to write data in the memory 870 or the port I/O 880 and to read data from the two. The memory 870 and the port I/O 880 are incorporated in the real CPU or provided outside the real CPU 800. Data stored in the register 810 is sent to an operation circuit 820 and calculated by the operation circuit 820, and the result is stored again in the register 810. A program counter (PC) 830 shows the address of an instruction that is being executed, while a stack pointer (SP) 840 shows the address of a stack. A status register (PSR) 850 stores data showing a flag (e.g., zero flag) that varies depending on the operation result and the status of the CPU. Since the C-source generated by the ISS generating device according to the present embodiment simulates the inside of the real CPU 800 as well, it has variables corresponding to the register 810, the PC 830, and the PSR 850.

The PSR 850 and the SP 840 are simulated by the host CPU's instruction designated by a function identifier in the technology file. In addition, the PC 830 generates an instruction for simulating the PC 830 in Step S830.

FIG. 17 illustrates a C-source file generated by the ISS generating device according to the present embodiment. In the C-source that is generated, a label for identifying the real CPU's address is set to the callee, and the fetch-stage instruction (fetch( )) and the execution-stage instruction operated on the host CPU corresponding to instructions in the application program are created. The C-source recreates operations of the instruction, and calculates the number of execution cycles.

An described above, the ISS generating device according to the present embodiment can generate ISS that capable of examining operations and execution time of an application program at high speed. Furthermore, it is applicable to various CPUs by simply adjusting the contents of the technology file and the position into which fetch-stage instructions are incorporated.

It should be understood that the invention is not limited to the above-mentioned embodiment, and various changes can be made without departing from the spirit and scope of the invention.

First Modification

A generic embedded software development tool may be used to generate an application program. In this case, an intermediate file is generated that stores information, such as information the program's addresses, instructions, and the callee's label. The intermediate file is used with the instruction database to search addresses and set address information. More specifically, the intermediate file is referred to search an instruction with the same address as the branch instruction in Step S370 in the process to search addresses and set address information as described in the flowchart of FIG. 8. Since the file stores the callee's label, it is possible to identify the callee's address with the label. Also in Step S390, the intermediate file is referred to search an instruction with the same address as the branch instruction. By tracing back the instruction in the file, it is possible to more accurately specify the callee's address since the callee's address is used in the instruction storing the callee.

Second Modification

While fetch stages coming in row at branching are processed with a fetch-stage instruction in the present embodiment, the same processing as the fetch-stage instruction may be added to the end of the execution-stage instruction of the branch instruction. Accordingly, branching with conditions in the fetch-stage instruction becomes unnecessary, thereby largely reducing branching with conditions executed while operating ISS generated by the host CPU and providing higher speed operations.

Third Modification

While the present embodiment provides a unit to simulate the status of the status register, the status of the stack, and the value of the program counter to be output as a log, only the status of the status register and the value of the program counter may be simulated as a log. Accordingly, there is no need to create an instruction for simulating the status of the stack, thereby increasing the speed to generate ISS.

Fourth Modification

It is also possible to output only the status of the status register as a log. Accordingly, it is possible to increase not only the speed to generate ISS but also the execution speed of an ISS program.

What is claimed is:

1. An instruction-set-simulator generating device that generates an instruction-set-simulator program for simulating an instruction execution process of a real central processing unit on a host central processing unit that differs from the real central processing unit, the instruction-set-simulator generating device comprising:
an application-program reading unit that reads an application program that is executable on the real central processing unit;
an execution-stage instruction conversion unit that converts a function of an instruction in the application program into at least one instruction (execution-stage instruction) for simulation on the host central processing unit;
a fetch-stage instruction generating unit that generates at least one instruction (fetch-stage instruction) that simulates operation timing of an instruction fetch stage among pipeline stages of the real central processing unit prior to the execution-stage instruction; and
an instruction-set-simulator program output unit that generates the instruction-set-simulator program based on the execution-stage instruction and the fetch-stage instruction;
at least one of the execution-stage instruction conversion unit and the fetch-stage instruction generating unit generating a counter instruction for simulating an execution time of the real central processing unit.

2. The instruction-set-simulator generating device according to claim 1,
the fetch-stage instruction generating unit determining timing of executing the fetch-stage instruction depending on time from start of the fetch stage to start of the execution stage among the pipeline stages of the real central processing unit.

3. The instruction-set-simulator generating device according to claim 1, further comprising:
an instruction conversion information storage unit that stores instruction conversion information that sets correspondence between an instruction in the application program and the execution-stage instruction;
the execution-stage instruction conversion unit converting an instruction in the application program into the execution-stage instruction with reference to the instruction conversion information.

4. The instruction-set-simulator generating device according to claim 3,
the instruction conversion information including information of an instruction execution-cycle number on the real central processing unit, and
the execution-stage instruction conversion unit generating the counter instruction for counting the execution-cycle number.

5. The instruction-set-simulator generating device according to claim 4,
the fetch-stage instruction generating unit generating the counter instruction for counting a fetch cycle in the pipeline stages of the real central processing unit.

6. The instruction-set-simulator generating device according to claim 1, further comprising:
an address search unit that searches a start address of the application program and a caller's address and a callee's address for branching; and
an address information setting unit that sets address information that specifies the start address of the application program and the caller's and callee's addresses in the instruction-set-simulator program.

7. The instruction-set-simulator generating device according to claim 6,
if the callee's address is designated by indirect addressing for designating a specific location storing the callee's address to designate the callee's address, the address search unit tracing back instructions from a branch instruction to specify the callee's address among data stored in the specific location.

8. The instruction-set-simulator generating device according to claim 6,
the address search unit searching the start address of the application program and the caller's and callee's addresses for branching with reference to the address information output at generation of the application program.

9. The instruction-set-simulator generating device according to claim 1,
the execution-stage instruction conversion unit judging whether a flag of a status register changed by an instruction in the application program is required for subsequent processing, and if not, opting not to generate an instruction for changing the flag.

10. The instruction-set-simulator generating device according to claim 1,
the execution-stage instruction conversion unit replacing two or more instructions in row in the application program with a smaller number of instruction(s) with an identical function.

11. The instruction-set-simulator generating device according to claim 1, further comprising:
a generating unit that generates at least one of an instruction for simulating a status of a stack of the real central processing unit and an instruction for simulating a value of a program counter of the real central processing unit.

12. The instruction-set-simulator generating device according to claim 11, further comprising:
a generating unit that generates at least one of an instruction for outputting a status of a flag of the status register of the real central processing unit, an instruction for outputting a status of the stack, and an instruction for outputting a value of the program counter of the real central processing unit.

13. The instruction-set-simulator generating device according to claim 11, further comprising:
a selection unit that selects an instruction to be generated among an instruction for outputting a status of a flag of the status register of the real central processing unit, an instruction for outputting a status of the stack of the real central processing unit, and an instruction for outputting a value of the program counter of the real central processing unit.

14. An instruction-set-simulator generating method that generates an instruction-set-simulator program for simulating an instruction execution process of a real central processing unit on a host central processing unit that differs from the real central processing unit, the instruction-set-simulator generating method comprising:
reading an application program that is executable on the real central processing unit;
converting a function of an instruction in the application program into at least one instruction (execution-stage instruction) for simulation on the host central processing unit;
generating at least one instruction (fetch-stage instruction) that simulates operation timing of an instruction fetch stage among pipeline stages of the real central processing unit prior to the execution-stage instruction; and
outputting the instruction-set-simulator program to generate the instruction-set-simulator program based on the execution-stage instruction and the fetch-stage instruction;
at least one of converting into the execution-stage instruction and generating the fetch-stage instruction generating a counter instruction for simulating an execution time of the real central processing unit.

15. An instruction-set-simulator generating program that makes a computer achieve a function that generates an instruction-set-simulator program for simulating an instruction execution process of a real central processing unit on a host central processing unit that differs from the real central processing unit,
the instruction-set-simulator generating program making the computer function as:
an application-program reading unit that reads an application program that is executable on the real central processing unit;
an execution-stage instruction conversion unit that converts a function of an instruction in the application program into at least one instruction (execution-stage instruction) for simulation on the host central processing unit;
a fetch-stage instruction generating unit that incorporates at least one instruction (fetch-stage instruction) that simulates operation timing of an instruction fetch stage among pipeline stages of the real central processing unit prior to the execution-stage instruction; and
an instruction-set-simulator program output unit that generates the instruction-set-simulator program based on the execution-stage instruction and the fetch-stage instruction;
one of the execution-stage instruction conversion unit and the fetch-stage instruction generating unit generating a counter instruction for simulating a clock of the real central processing unit.

16. The instruction-set-simulator generating program according to claim 15,
the fetch-stage instruction generating unit determining timing of executing the fetch-stage instruction depending on time from start of the fetch stage to start of the execution stage among the pipeline stages of the real central processing unit.

17. The instruction-set-simulator generating program according to claim 15,
the program further making the computer function as:
an instruction conversion information storage unit that stores instruction conversion information that sets correspondence between an instruction in the application program and the execution-stage instruction;
the execution-stage instruction conversion unit converting an instruction in the application program into the execution-stage instruction with reference to the instruction conversion information.

18. A computer-readable storage medium, comprising:
the instruction-set-simulator generating program according to claim 15 stored in the storage medium.

19. An instruction-set-simulator program generated by the instruction-set-simulator generating device according to claim 1,
the instruction-set-simulator program making a computer achieve:
a first function that simulates operation timing of a fetch stage among the pipeline stages at execution of the application program on the real central processing unit;
a second function that simulates a function of an execution stage among the pipeline stages at execution of the application program on the real central processing unit; and
a third function that simulates an execution-cycle number of the application program on the real central processing unit.

20. An instruction-set-simulator system that simulates an instruction execution process of an application program on a host central processing unit that differs from a real central processing unit, the instruction-set-simulator system comprising:
the instruction-set-simulator generating device according to claim 1;
a compiling device that compiles the instruction-set-simulator program generated by the instruction-set-simulator generating device and generating an instruction-set-simulator execution program that is executable on the host central processing unit; and
an instruction-set-simulator device that stores the instruction-set-simulator execution program;
the instruction-set-simulator device executing the instruction-set-simulator execution program on the host central processing unit.
